(19) United States
(12) Patent Application Publication
(10) Pub. No.: US 2012/0049079 A1
(43) Pub. Date: Mar. 1, 2012

(54) ELECTRONIC ASSEMBLY

(75) Inventors: Brian David Yanoff, Niskayuna, NY (US); Charles Gerard Woychik, Niskayuna, NY (US); Yanfeng Du, Rexford, NY (US); James Wilson Rose, Guilderland, NY (US)

(73) Assignee: GENERAL ELECTRIC COMPANY, SCHENECTADY, NY (US)

(21) Appl. No.: 12/873,107

(22) Filed: Aug. 31, 2010

Related U.S. Application Data
(60) Provisional application No. 61/376,418, filed on Aug. 24, 2010.

(51) Int. Cl. G01T 1/24

(52) U.S. Cl. 250/370.13; 250/370.01

(57) ABSTRACT

An electronic assembly is provided. The assembly comprises a substrate having a plurality of conductive contacts disposed on a surface of the substrate. The substrate comprises a dielectric material. The assembly comprises a detector having a plurality of conductive contacts disposed on a surface of the detector which is adjacent to the surface of the substrate. At least one compliant interconnect is disposed between the substrate and the detector. The conductive contacts of the substrate and the conductive contacts of the detector are in electrical communication with the compliant interconnect via a conductive epoxy. The compliant interconnect comprises a polymer core having an electrically conductive outer surface. In certain embodiments, the assembly comprises an interposer. In certain embodiments, an under-fill is disposed between the surface of the substrate and the surface of the detector.

### STATEMENT REGARDING FEDERALLY SPONSORED RESEARCH & DEVELOPMENT

This invention was made with Government support under contract number HSHQDC-06-C-00089, awarded by the Domestic Nuclear Detection Office. The Government has certain rights in the invention.

### BACKGROUND

The invention includes embodiments that relate to an electronic assembly such as that used in portable detectors. More particularly, the invention includes embodiments that relate to packaging an electronic assembly used in portable spectroscopic radiation detectors.

### DISCUSSION OF RELATED ART

Various techniques of packaging electronic assemblies are known in the art. Electronic assemblies require electrical coupling of crystal detectors or integrated circuits to conductive traces of a substrate. The electrical couplings are typically achieved by disposing solder bumps or conductive epoxy to connect the detector or circuit with the substrate. Matching the coefficient of thermal expansion (CTE) of the substrate with the detector or integrated circuit material is desirable to ensure long-term reliability of the electrical connections during the use of the electronic assembly.

For example, cadmium zinc telluride (CZT) and cadmium telluride (CdTe) crystal detectors are commonly used in X-ray devices in the form of single elements or as monolithic segmented arrays. Such detectors are known to be useful in imaging systems utilized in medical, research, security, or industrial applications. CdTe and CZT detectors inherently possess better energy resolution compared to scintillation-based detectors and therefore lead to radiation spectroscopy systems with improved isotope identification capabilities. Stress induced by temperature changes may cause cracking of the CZT, particularly around the perimeter. For example, the difference in shrinkage because of the different CTE of the substrate and CZT during the cool down process following the curing of the conductive epoxy that is used to connect the substrate and the CZT may cause cracking of the CZT crystal. Substrates and packages for CZT detectors are usually made from ceramic materials, such as alumina, because of their approximate CTE match to CZT and their low dielectric loss tangent. In some cases an organic substrate such as a fluoropolymer-based HyperBGA® may be used in the package. The HyperBGA® is known to have excellent dielectric loss tangent, and is capable of achieving higher routing densities than ceramic substrates. HyperBGA® is also known to support many pixels of the detector crystal in a small space. However the CTE mismatch between organic substrates and CZT (organic substrate have a higher CTE than CZT) may cause cracking of the CZT crystal. Another approach to avoid damage to the CZT may include use of a ceramic interposer between the CZT and the organic substrate. The stiff interposer may help to minimize the stress caused by the CTE mismatch, thus preventing damage to the CZT crystal. However, in addition to the ceramic material having lower routing densities than the organic substrate, using a ceramic interposer may require additional parts and steps in the assembly process. This may lead to an increase in the packaging cost.

Thus, there is a continuing need for improved packaging of electronic assemblies that enable organic, and other high CTE substrates, to be used with delicate detector materials. Additionally, it may be desirable to have an electronic assembly where the materials are mechanically stiff and CTE matched, while preserving the high routing density and other benefits of organic substrates.

### BRIEF DESCRIPTION

In one embodiment, an electronic assembly is provided. The assembly consists of a substrate having a plurality of conductive contacts disposed on a surface of the substrate. The substrate comprises a dielectric material. The assembly comprises a detector having a plurality of conductive contacts disposed on a surface of the detector that is adjacent to the surface of the substrate. At least one compliant interconnect is disposed between the substrate and the detector. The conductive contacts of the substrate and the conductive contacts of the detector are in electrical communication with the compliant interconnect via a conductive epoxy. The compliant interconnect comprises a polymer core having an electrically conductive outer surface.

In another embodiment, an electronic assembly is provided. The assembly comprises a substrate comprising a dielectric material and an interposer comprising a ceramic material. At least one first interconnect is disposed to establish an electrical communication between the interposer and the substrate via a solder joint. A detector is disposed over the ceramic interposer. At least one second interconnect is disposed to establish an electrical communication between the detector and the interposer via a conductive epoxy joint. The second interconnect comprises a polymer core having an electrically conductive outer surface.

In yet another embodiment, an electronic assembly is provided. The assembly comprises a substrate having a plurality of conductive contacts disposed on a surface of the substrate. The substrate comprises a dielectric material. The assembly comprises a detector having a plurality of conductive contacts disposed on a surface of the detector that is adjacent to the surface of the substrate. At least one compliant interconnect is disposed between the substrate and the detector. The conductive contacts of the substrate and the conductive contacts of the detector are in electrical communication with the interconnect via a conductive epoxy. The compliant interconnect comprises a polymer core having an electrically conductive outer surface. An under-fill is disposed between the surface of the substrate and the surface of the detector.

In yet another embodiment, an electronic assembly is provided. The assembly comprises a substrate comprising a dielectric material and an interposer comprising a ceramic material. At least one first interconnect is disposed to establish an electrical communication between the interposer and the substrate via a solder joint. A detector is disposed over the ceramic interposer. At least one second interconnect is disposed to establish an electrical communication between the detector and the interposer via a conductive epoxy joint. The second interconnect comprises a polymer core having an electrically conductive outer surface. The electrically conductive outer surface comprises gold.

### BRIEF DESCRIPTION OF DRAWINGS

FIG. 1 is a schematic view showing an electronic assembly in accordance with one embodiment of the invention;

FIG. 2 is a schematic view showing an electronic assembly in accordance with one embodiment of the invention;

FIG. 3 is a schematic view showing an electronic assembly in accordance with one embodiment of the invention;

FIG. 4 is a schematic view showing an electronic assembly in accordance with one embodiment of the invention;

FIG. 5 is a schematic view showing an electronic assembly in accordance with one embodiment of the invention; and

FIG. 6 is a schematic view showing an electronic assembly in accordance with one embodiment of the invention.

### DETAILED DESCRIPTION

Embodiments of the invention described herein address the noted shortcomings of the state of the art. The electronic assembly discussed herein provides a package to improve reliability of portable detectors. The use of compliant interconnects may help to reduce the transmission of thermally-induced stress from the substrate to the detector material. This may enable successful assembly of modules allowing improved overall detector performance and reliability. In one embodiment, compliant interconnects that minimize stress transfer from substrate to the detector are disposed between the substrate and the detector. The substrate, the detector, and the compliant interconnects are maintained in electrical contact through a conductive epoxy. In certain embodiments, an interposer may be employed between the substrate and the detector, in addition to the compliant interconnects. In some other embodiments, an under-fill may be used to fill the gaps between the compliant interconnects.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components unless otherwise stated. As used herein, the terms “disposed over” or “deposited over” or “disposed between” refers to both secured or disposed directly in contact with and indirectly by having intervening layers therebetween.

All ranges disclosed herein are inclusive of the endpoints, and the endpoints are combinable with each other. The terms “first,” “second,” and the like as used herein do not denote any order, quantity, or importance, but rather are used to distinguish one element from another.

Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

As used herein, the term “dielectric material” refers to a material that is an electrical insulator or in which an electric field can be sustained with a minimal dissipation of power.

As used herein, the term “coefficient of thermal expansion” (CTE) of any material refers to the linear expansion of the material under the effect of temperature. The CTE may be calculated using the following formula:

dL=a×L₁(T₂−T₁)
where, dL=L₂-L₁
   wherein dL is linear expansion, L₁ is initial length, T₁ is initial temperature, “a” is the coefficient of thermal expansion, T₂ is the final temperature and L₂ is the final length after thermal expansion.

As used herein, the term “solder joint” refers to a joint formed between two or more items by melting and flowing a filler metal into the joint and then solidifying the metal, the filler metal having a relatively low melting point. The filler metal used in the process is called solder. In one embodiment, the solder may be in the form of a sphere. As used herein, the term “solder compatible electrical contacts” refers to electrical contacts disposed on a surface of the substrate, the interposer, or the detector crystal. A solder-compatible contact can form a metallurgical bond with the solder material without compromising the desired electrical and mechanical properties of the solder material, contacts, or materials being joined. For example, pure gold is not usually considered a solder compatible contact because it dissolves into the solder, causing embrittlement of the solder material. A thin layer of gold over nickel plating is commonly done using an electroless nickel immersion gold (ENIG) process that (ENIG) is solder-compatible because the gold prevents oxidation, and a metallurgical bond is formed between the nickel and the solder.

As used herein, the term “mechanically stiff” refers to the stiffness i.e., the resistance of an elastic body to deformation by an applied force along a given degree of freedom (DOF) when a set of loading points and boundary conditions are prescribed on the elastic body. It is an extensive material property.

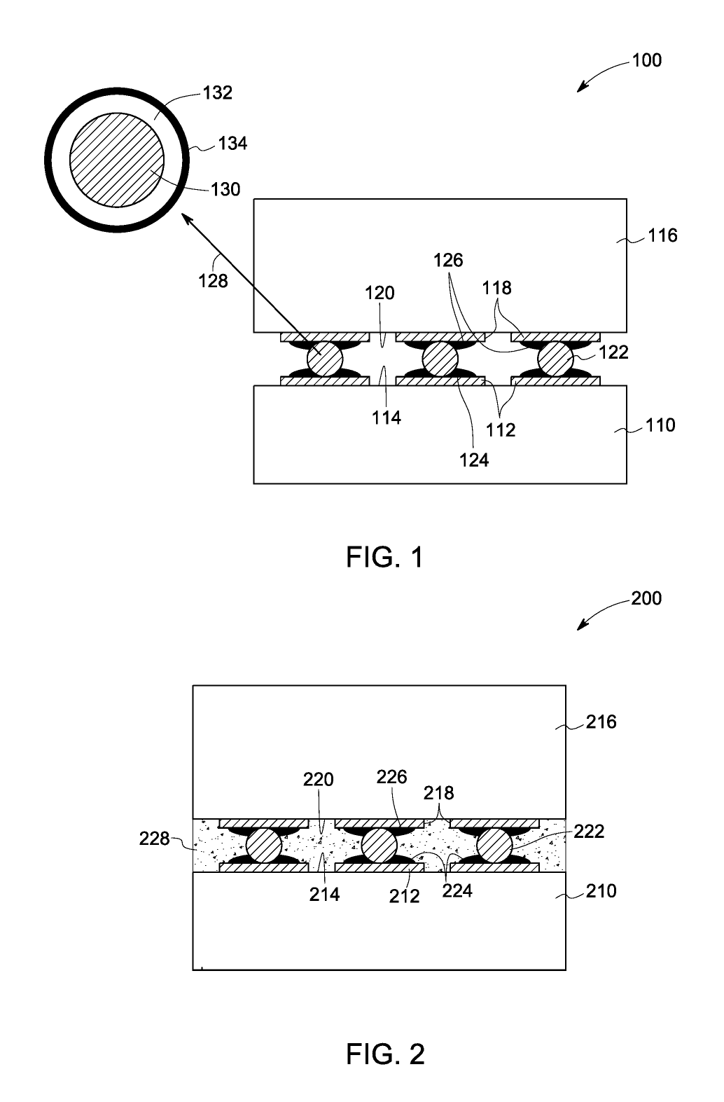

As demonstrated in FIG. 1, in one embodiment, an electronic assembly 100 is provided. The assembly comprises a substrate 110 having a plurality of conductive contacts 112 disposed on a surface 114 of the substrate 110. The substrate 110 comprises a dielectric material. The assembly 100 comprises a detector 116 having a plurality of conductive contacts 118 disposed on a surface 120 of the detector 116, which is adjacent to the surface 114 of the substrate 110. At least one compliant interconnect 122 is disposed between the substrate 110 and the detector 116. The conductive contacts of the substrate 112 and the conductive contacts of the detector 118 are in electrical communication with the compliant interconnect 122 via a conductive epoxy 124, 126. The compliant interconnect 122, as shown in the expanded image 128 comprises a polymer core 130 coated with a copper layer 132. The copper layer 132 is then coated with a protective metal coating, typically Au, on the outer surface 134.

The substrate 110 may typically be formed of any material which is sufficiently mechanically stiff to support the material and has a CTE such that the difference of the CTE of the substrate material and the CTE of the detector material is less than or equal to about 200 parts per million per degree Centigrade. As described above the overall change in length is proportional to the CTE and the original length of the material and hence the type and size of substrate used may be dependent on the size of the detector. In one embodiment, the substrate comprises a material having a CTE in a range of about 4 parts per million per degree Centigrade to about 200 parts per million per degree Centigrade. In another embodiment, the substrate comprises a material having a CTE in a range of about 5 parts per million per degree Centigrade to about 150 parts per million per degree Centigrade. In yet another embodiment, the substrate comprises a material having a CTE in a range of about 6 parts per million per degree Centigrade to about 100 parts per million per degree Centigrade.

In one embodiment, the substrate 110 comprises an organic material or a ceramic material. In one embodiment, the organic substrate comprises a material having a CTE in a range from about 8 parts per million per degree Centigrade to about 50 parts per million per degree Centigrade. In another embodiment, the substrate comprises a material having a CTE in a range from about 10 parts per million per degree Centigrade to about 45 parts per million per degree Centigrade. In yet another embodiment, the substrate comprises a material having a CTE in a range from about 20 parts per million per degree Centigrade to about 40 parts per million per degree Centigrade. In one embodiment, the organic material comprises a thermoplastic polymer or a thermosetting polymer. In one embodiment, the organic material comprises a polycarbonate, a polyester, a polyimide, a polyurethane, a polycyanurate, a phenolic resin, or an epoxy resin. Suitable examples of organic materials that can be employed as the substrate 110 include bismaleimide triazine (BT), polytetrafluoroethylene (Teflon®), phenol-formaldehyde resin, phenol novola cyanate ester (Primaset®) and poly(4,4′-oxydiphenylene-pyromellitimide) (Kapton®).

In one embodiment, the ceramic substrate comprises a material having a CTE in a range from about 5 parts per million per degree Centigrade to about 15 parts per million per degree Centigrade. In another embodiment, the ceramic comprises a material having a CTE in a range from about 6 parts per million per degree Centigrade to about 12 parts per million per degree Centigrade. In yet another embodiment, the ceramic comprises a material having a CTE in a range from about 7 parts per million per degree Centigrade to about 10 parts per million per degree Centigrade. In one embodiment, the ceramic material comprises an oxide, a nitride, or a carbide of materials selected from group IIIA and group IVA of the periodic table. In one embodiment, the ceramic material comprises alumina, silicon nitride, aluminum nitride, silicon carbide, or silica.

In one embodiment, the detector 116 comprises a semiconductor material. The detector material includes materials that inherently possess high energy resolution leading to compact imaging systems or to imaging systems of enhanced spatial resolution and improved contrast resolution. As mentioned above, the detector material employed may have a difference in CTE of less than or equal to 200 parts per million per degree Centigrade over the CTE of the substrate material 110. In one embodiment, the detector comprises a material having a CTE in a range from about 5 parts per million per degree Centigrade to about 50 parts per million per degree Centigrade. In another embodiment, the detector comprises a material having a CTE in a range from about 6 parts per million per degree Centigrade to about 45 parts per million per degree Centigrade. In yet another embodiment the detector comprises a material having a CTE in a range from about 7 parts per million per degree Centigrade to about 40 parts per million per degree Centigrade.

Suitable materials that may be used as the detector may be selected from the group consisting of silicon (Si), silicon germanium (SiGe), germanium (Ge), gallium arsenide (GaAs), indium phosphide (InP), gallium indium phosphide (GaInP), indium gallium arsenide (InGaAs), indium nitride (InN), selenium (Se), cadmium telluride (CdTe), cadmium zinc Telluride (CdZnTe), cadmium oxygen telluride (Cd—O—Te), cadmium manganese oxygen telluride (Cd—Mn—O—Te), zinc telluride (ZnTe), zinc oxygen telluride (Zn—O—Te), zinc manganese oxygen telluride (Zn—Mn—O—Te), manganese telluride (MnTe), manganese oxygen telluride (Mn—O—Te), oxides of copper, carbon, mercuric iodide (HgI₂), lead iodide (PbI₂), lead oxide (PbO), thallium bromide (TIBr), thallium iodide (TlI), copper indium gallium seleninde (Cu—In—Ga—Se), and copper indium selenide (Cu—In—Se). In one embodiment, the detector material is cadmium zinc telluride.

A compliant interconnect typically functions to minimize the mechanical stress transmitted to the detector, for example, stress encountered during handling of the instrument. Accordingly the compliant interconnect may have a relatively low Young's modulus such that the compliant interconnect transfers a lower stress to the detector than an interconnect that is not compliant. This may help in minimizing or avoiding the stress that is transmitted to the detector material. In assemblies where the joint is connected with an interconnect having a Young's modulus much less than 0.2 giga-pascal, the joint may lack mechanical integrity. In one embodiment, the compliant interconnect comprises a material having a Young's modulus in a range from about 0.2 giga-pascal to about 3.5 giga-pascal. In another embodiment, the compliant interconnect comprises a material having a Young's modulus in a range from about 0.4 giga-pascal to about 2.0 giga-pascal. In yet another embodiment, the compliant interconnect comprises a material having a Young's modulus in a range from about 0.5 giga-pascal to about 0.8 giga-pascal. In one embodiment, the polymer core of the compliant interconnect is spherical. The polymer core may serve the purpose of lowering the thermo-mechanical stresses.

In one embodiment, the difference in the CTE of the detector and the substrate is less than about 200 parts per million per degree Centigrade. In another embodiment the difference in the CTE of the detector and the substrate is less than about 100 parts per million per degree Centigrade. In yet another embodiment, the difference in the CTE of the detector and the substrate is less than about 50 parts per million per degree Centigrade.

In one embodiment, the electrically conductive outer surface of the compliant interconnect comprises a noble metal. In one embodiment, the metal comprises gold or platinum. In one embodiment, the metal comprises gold. In one embodiment, the metal comprises electroless nickel immersion gold (ENIG). ENIG is a type of surface plating used for printed circuit boards. The plating includes an electroless nickel plating covered with a thin layer of immersion gold, which protects the nickel from oxidation

In one embodiment, the polymer core of the compliant interconnect comprises a polymer having a Young's modulus of about 0.2 giga-pascal to about 3.5 giga-pascal, a Poisson's ratio of less than about 0.5, and a CTE of less than or equal to about 50 parts per million per degree Centigrade. The low modulus of the polymer (compared, for example to the Young's modulus of ceramic at about 300 giga-pascal) may allow the interconnect to deform under stress thereby reducing the stress being transmitted to the detector. Any suitable polymer material known to one skilled in the art may be employed in the compliant interconnect. Suitable examples of the polymer include polyethylene, polystyrene, polycarbonate, melamine resin, polytetrafluoroethylene, and divinyl benzene. In one embodiment, the polymer has a Young's modulus in a range from about 0.4 giga-pascal to about 0.8 giga-pascal as found in for example divinyl benzene or polytetrafluoroethylene. In one embodiment, the polymer has a Young's modulus in a range from about 0.2 giga-pascal to about 0.8 giga-pascal as found in for example, polyethylene. In one embodiment, the polymer has a Young's modulus in a range from about 2 giga-pascal to about 3.5 giga-pascal as found in for example, polystyrene or polycarbonate.

Referring to FIG. 2, an electronic assembly 200 is provided. The assembly comprises a substrate 210 having a plurality of conductive contacts 212 disposed on a surface 214 of the substrate 210. The substrate 210 comprises a dielectric material. The assembly 200 further comprises a detector 216 having a plurality of conductive contacts 218 disposed on a surface 220 of the detector 216 which is adjacent to the surface 214 of the substrate 210. At least one compliant interconnect 222 is disposed between the substrate 210 and the detector 216. The conductive contacts of the substrate 212 and the conductive contacts of the detector 218 are in electrical communication with the compliant interconnect 222 via a conductive epoxy 224, 226. An under-fill 228 is disposed between the surface 214 of the substrate 210 and the surface 220 of the detector 216. Under-fill materials such as epoxies have been employed to improve the mechanical reliability of integrated circuits (ICs) by filling the space between the IC and the substrate. However, these are not routinely used with CZT detectors, in part because of the additional mechanical stress they may induce on the CZT. In certain embodiments, as referred to in FIG. 2, the assembly 200 may further comprise an under-fill 228. The under-fill may be employed to fill the spaces between the interconnects 222. In various embodiments the under-fill 228 may include a flow-able under-fill or a no-flow under-fill. As known in the art, a flow-able under-fill is applied at the perimeter of the part (such as a flip chip integrated circuit) after the chip is interconnected to the substrate. The flow-able under-fill wicks under the chip by capillary action. A no-flow under-fill is deposited before the chip is attached, and usually bonds the parts together in the same step when the solder is melted to bond the parts. Suitable examples of under-fill 228 include an epoxy resin system, such as a reaction product of epichlorohydrin & bisphenol A, Epo-Tek9® T7110 or Masterbond EP62-1. In various embodiments, the epoxy resin system may include thermally curable, ultraviolet curable, or microwave curable epoxy resin.

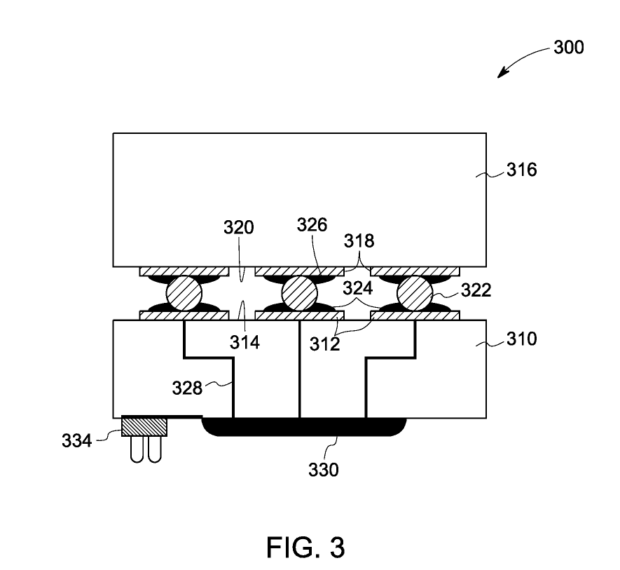

Referring to FIG. 3, one example of an electronic assembly 300 is provided. The assembly comprises a substrate 310 having a plurality of conductive contacts 312 disposed on a surface 314 of the substrate 310. The substrate 310 comprises a dielectric material. The assembly 300 comprises a detector 316 having a plurality of conductive contacts 318 disposed on a surface 320 of the detector 316, which is adjacent to the surface 314 of the substrate 310. At least one compliant interconnect 322 is disposed between the substrate 310 and the detector 316. The conductive contacts 312 of the substrate 310 and the conductive contacts 318 of the detector 316 are in electrical communication with the compliant interconnect 322 via a conductive epoxy 324, 326. Vias 328 are provided through the substrate 310 for routing the input signals from the detector 316 to the readout application specific integrated chips (ASIC) 330. The ASIC 330 is disposed on the surface 332 of the substrate 310. A connector 334 is also disposed on surface 332 of the substrate 310 which forms the interfaces to motherboard support electronics (not shown in figure). The relatively low elastic modulus of the compliant interconnects allows them to deform when mechanical stress is applied between the detector and substrate or interposer. This reduces the stress on the detector, preventing damage to the material or to the interconnect.

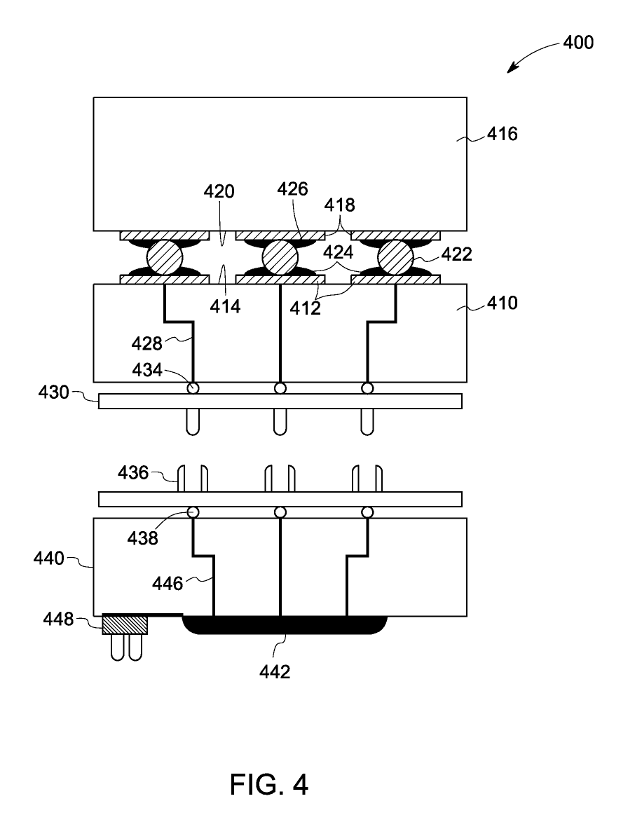

Referring to FIG. 4, another example of an electronic assembly 400 is provided. The assembly comprises a substrate 410 having a plurality of conductive contacts 412 disposed on a surface 414 of the substrate 410. The substrate 410 comprises a dielectric material. The assembly 400 comprises a detector 416 having a plurality of conductive contacts 418 disposed on a surface 420 of the detector 416 which is adjacent to the surface 414 of the substrate 410. At least one compliant interconnect 422 is disposed between the substrate 410 and the detector 416. The conductive contacts of the substrate 412 and the conductive contacts 418 of the detector 416 are in electrical communication with the compliant interconnect 422 via a conductive epoxy 424, 426. Vias 428 are provided through the substrate 410 for routing the input signals from the detector 416 to a first connector interface 430 to readout ASIC 432. A first solder joint 434 is disposed to establish an electrical communication between the substrate 410 and a first connector 430. The first solder joint 434 is aligned to the vias 428 in the substrate 410, which means that every via 428 in the substrate 410 has a corresponding solder joint 434. The vias 428 are aligned to the corresponding solder joint to establish the electrical communication between the substrate 410 and the first connector 430. The first connector 430 is aligned to connector sockets 436 such that the first connector 430 fits into matching connector sockets 436 to establish an electrical communication between the first connector 430 and the connector socket 436. A second solder joint 438 is disposed to establish an electrical connection between an ASIC daughter card 440 and the connector sockets 436. An ASIC 442 is disposed over a surface 444 of the ASIC daughter card 440. The ASIC 442 is electrically connected to the connector sockets 436 through vias 446 in the ASIC daughter card 440 and the second solder joints 438. A second connector interface 448 to the mother board (not shown in figure) is disposed on the surface 444 of the ASIC daughter card 440. As used herein the term “vias” refer to the through-hole paths to the other surface. Vias allow the electrical and thermal connection of conductors on opposite sides of a substrate. The relatively low elastic modulus of the compliant interconnects allows them to deform when mechanical stress is applied between the detector and substrate or interposer. This reduces the stress on the detector, preventing damage to the material or to the interconnect.

The material employed for the first solder joint 434 may include any suitable material known in the art as useful for forming a solder joint. Suitable solder joint materials may include lead-tin (PbSn) solder, or lead-free solders, such as Sn—Ag—Cu (SAC) alloys. Other solder materials may include elements such as bismuth that reduce the melting point of the solders.

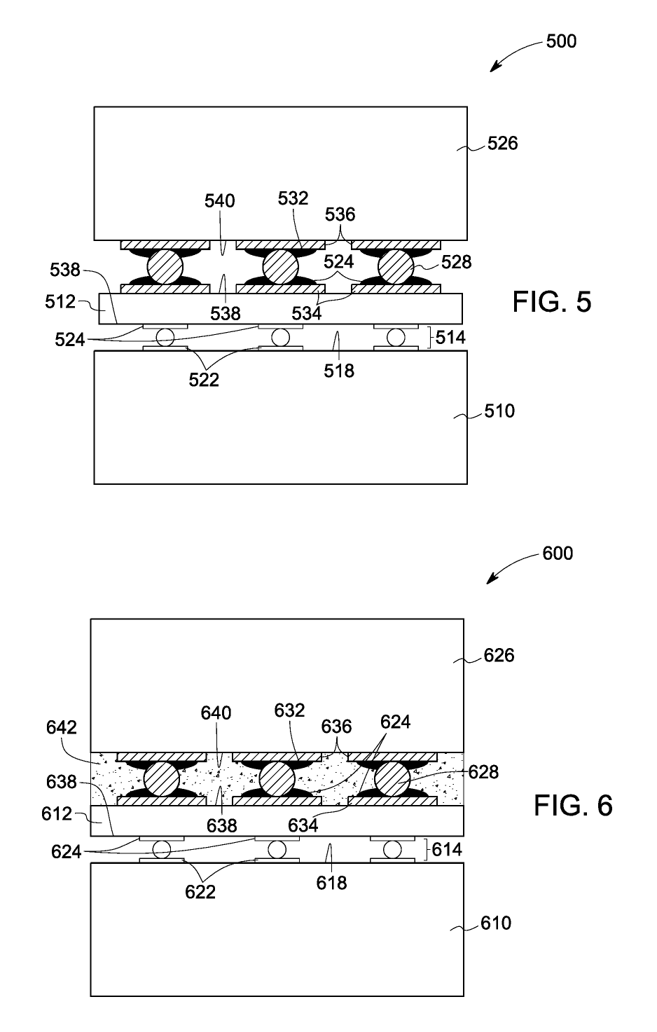

As shown in FIG. 5, in another embodiment, an electronic assembly 500 is provided. The assembly 500 comprises a substrate 510 comprising a dielectric material and an interposer 512 comprising a dielectric material. At least one first interconnect is disposed to establish an electrical communication between the interposer 512 and the substrate 510 via a solder joint 514. Solder compatible electrical contacts 522 and 524 are disposed over the surface 518 of the substrate 510 and the surface 520 of the interposer 512 respectively. The solder joint 514 (solder ball) is disposed between the contacts 522 and 524. A detector 526 is disposed over the interposer 512. Electrical contacts 534 and 536 are disposed over the surface 538 of the interposer 512 and the surface 540 of the detector 526 respectively. At least one second interconnect 528 is disposed between the electrical contacts 534 and 536 to establish an electrical communication between the detector 526 and the interposer 512 via a conductive epoxy joint 530, 532. The second interconnect 528 comprises a polymer core having an electrically conductive outer surface as described above in FIG. 1.

The interposer 512 may comprise a material that is mechanically stiff and has a CTE such that the difference of the CTE of the interposer material and the CTE of the detector material is less than or equal to about 200 parts per million per degree Centigrade. In various embodiments, the interposer may comprise similar materials as discussed for the substrate 110 above. In one embodiment, the interposer comprises an organic material or a ceramic material. In one embodiment, the organic material comprises a thermoplastic polymer or a thermosetting polymer. In one embodiment, the organic material comprises a polycarbonate, a polyester, a polyimide, a polyurethane, a polycyanurate, a phenolic resin, or an epoxy resin. In one embodiment, the organic material has a coefficient of thermal expansion in a range from about 8 parts per million per degree Centigrade to about 50 parts per million per degree Centigrade. In one embodiment, the ceramic material comprises an oxide, a nitride, or a carbide of materials selected from group IIIA and group IVA of the periodic table. In one embodiment, the ceramic material comprises alumina, silicon nitride, aluminum nitride, silicon carbide, or silica. In one embodiment, ceramic material has a coefficient of thermal expansion in a range from about 5 parts per million per degree Centigrade to about 15 parts per million per degree Centigrade.

In one embodiment, the difference in the CTE of the detector and the interposer is less than about 200 parts per million per degree Centigrade. In another embodiment the difference in the CTE of the detector and the interposer is less than about 100 parts per million per degree Centigrade. In yet another embodiment, the difference in the CTE of the detector and the interposer is less than about 50 parts per million per degree Centigrade.

As shown in FIG. 6, in another embodiment, an electronic assembly 600 is provided. The assembly comprises a substrate 610 comprising a dielectric material and an interposer 612 comprising a ceramic material. At least one first interconnect is disposed to establish an electrical communication between the interposer 612 and the substrate 610 via a solder joint 614. Solder compatible electrical contacts 622 and 624 are disposed over the surface 618 of the substrate 610 and the surface 620 of the interposer 612 respectively. The solder joint 614 (solder ball) is disposed between the contacts 622 and 624. A detector 626 is disposed over the ceramic interposer 612. Electrical contacts 634 and 636 are disposed over the surface 638 of the interposer 612 and the surface 640 of the detector 626 respectively. At least one second interconnect 628 is disposed between the electrical contacts 634 and 636 to establish an electrical communication between the detector 626 and the interposer 612 via a conductive epoxy joint 630, 632. The second interconnect 628 comprises a polymer core having an electrically conductive outer surface as described above in FIG. 1. An under-fill 648 is disposed between the surface 640 of the detector 626 and the surface 638 of the interposer 612.

Referring to FIG. 5, in another embodiment, an electronic assembly 500 is provided. The assembly comprises a substrate 510 comprising a dielectric material and an interposer 512 comprising a ceramic material. At least one first interconnect is disposed to establish an electrical communication between the interposer 512 and the substrate 510 via a solder joint 514. Solder compatible electrical contacts 522 and 524 are disposed over the surface 518 of the substrate 510 and the surface 520 of the interposer 512 respectively. The solder joint 514 (solder ball) is disposed between the contacts 522 and 524. A detector 526 is disposed over the ceramic interposer 512. Electrical contacts 534 and 536 are disposed over the surface 538 of the interposer 512 and the surface 540 of the detector 526 respectively. At least one second interconnect 528 is disposed between the electrical contacts 534 and 536 to establish an electrical communication between the detector 526 and the interposer 512 via a conductive epoxy joint 530, 532. The second interconnect 528 comprises a polymer core having an electrically conductive outer surface (not shown in figure), wherein the electrically conductive outer surface comprises gold.

Referring back to FIG. 3, in one embodiment, an electronic assembly 300 is provided. The assembly includes an ASIC chip 332 disposed on the surface of the substrate 310. The ASIC chip is attached to the substrate 310 using conventional die-attach adhesive as known to one skilled in the art. The chip is wire bonded (not shown in figure) to the conductive contacts 312 disposed on the substrate 310. The ASIC may also be configured to allow flip-chip attachment directly to the substrate 310, without the need for wire bonding. When the ASIC is directly attached to the substrate 310, the substrate can provide mechanical support for the ASIC, and can also route the signals between the ASIC and detector 316 via the vias 328 when the spacing between the ASIC channels (not shown in figure) and detector pixels (not shown in figure) is not uniform. As known in the art, “flip chip” is a method for interconnecting semiconductor devices, such as integrated circuit chips, to external circuitry with solder bumps that have been deposited onto the chip pads. The solder bumps are deposited on the chip pads on the top side of the wafer during the final wafer processing step. In order to mount the chip to external circuitry (e.g., a circuit board or another chip or wafer), it is flipped over so that its top side faces down, and is aligned so that its pads align with matching pads on the external circuit, and then the solder is flowed to complete the interconnect.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electronic assembly comprising:
a substrate having a plurality of conductive contacts disposed on a surface of the substrate, wherein the substrate comprises a dielectric material;
a detector having a plurality of conductive contacts disposed on a surface of the detector which is adjacent to the surface of the substrate;
at least one compliant interconnect disposed between the substrate and the detector, wherein the conductive contacts of the substrate and the conductive contacts of the detector are in electrical communication with the interconnect via a conductive epoxy, and wherein the compliant interconnect comprises a polymer core having an electrically conductive outer surface.

2. The assembly of claim 1, wherein the substrate comprises an organic material or a ceramic material.

3. The assembly of claim 2, wherein the organic material comprises a thermoplastic polymer or a thermosetting polymer.

4. The assembly of claim 2, wherein the organic material comprises a polycarbonate, a polyester, a polyimide, a polyurethane, a polycyanurate, a phenolic resin, or an epoxy resin.

5. The assembly of claim 2, wherein the organic material has a coefficient of thermal expansion in a range from about 8 parts per million per degree Centigrade to about 50 parts per million per degree Centigrade.

6. The assembly of claim 2, wherein the ceramic material comprises an oxide, a nitride, or a carbide of materials selected from group IIIA and group IVA of the periodic table.

7. The assembly of claim 2, wherein the ceramic material comprises alumina, silicon nitride, aluminum nitride, silicon carbide, or silica.

8. The assembly of claim 2, wherein the ceramic material has a coefficient of thermal expansion in a range from about 5 parts per million per degree Centigrade to about 15 parts per million per degree Centigrade.

9. The assembly of claim 1, wherein the detector comprises a semiconductor material selected from the group consisting of silicon (Si), silicon germanium (SiGe), germanium (Ge), gallium arsenide (GaAs), indium phosphide (InP), gallium indium phosphide (GaInP), indium gallium arsenide (InGaAs), indium nitride (InN), selenium (Se), cadmium telluride (CdTe), cadmium zinc telluride (CdZnTe), cadmium oxygen telluride (Cd—O—Te), cadmium manganese oxygen telluride (Cd—Mn—O—Te), zinc telluride (ZnTe), zinc oxygen telluride (Zn—O—Te), zinc manganese oxygen telluride (Zn—Mn—O—Te), manganese telluride (MnTe), manganese oxygen telluride (Mn—O—Te), oxides of copper, carbon, mercuric iodide (HgI₂), lead iodide (PbI₂), lead oxide (PbO), thallium bromide (TlBr), thallium iodide (TlI), copper indium gallium seleninde (Cu—In—Ga—Se), and copper indium selenide (Cu—In—Se).

10. The assembly of claim 1, wherein the detector has a CTE in a range of about 5 parts per million per degree Centigrade to about 50 parts per million per degree Centigrade.

11. The assembly of claim 1, wherein the compliant interconnect has a Young's modulus in a range of about 0.2 giga-pascal to about 3.5 giga-pascal.

12. The assembly of claim 1, wherein the electrically conductive outer surface of the compliant interconnect comprises a noble metal.

13. The assembly of claim 1, wherein the polymer of the compliant interconnect comprises divinyl benzene or melamine resin.

14. The assembly of claim 1, wherein the polymer core is spherical.

15. The assembly of claim 1, further comprising an under-fill.

16. The assembly of claim 1, wherein the under-fill comprises an epoxy resin system.

17. The assembly of claim 16, wherein the epoxy resin system is a thermally, ultraviolet, or microwave curable epoxy resin.

18. The assembly of claim 1, wherein the detector is a flip-chip.

19. An electronic assembly comprising:
a substrate comprising a dielectric material;
an interposer comprising a dielectric material;
at least one first interconnect disposed to establish an electrical communication between the interposer and the substrate via a solder joint;
a detector disposed over the ceramic interposer; and
at least one second interconnect disposed to establish an electrical communication between the detector and the interposer via a conductive epoxy joint, wherein the second interconnect comprises a polymer core having an electrically conductive outer surface.

20. The assembly of claim 19, wherein the substrate comprises an organic material or a ceramic material.

21. The assembly of claim 19, wherein the interposer comprises an organic material or a ceramic material.

22. The assembly of claim 21, wherein the organic material comprises a thermoplastic polymer or a thermosetting polymer.

23. The assembly of claim 21, wherein the organic material comprises a polycarbonate, a polyester, a polyimide, a polyurethane, a polycyanurate, a phenolic resin, or an epoxy resin.

24. The assembly of claim 21, wherein the organic material has a coefficient of thermal expansion in a range from about 8 parts per million per degree Centigrade to about 50 parts per million per degree Centigrade.

25. The assembly of claim 21, wherein the ceramic material comprises an oxide, a nitride, or a carbide of materials selected from group IIIA and group IVA of the periodic table.

26. The assembly of claim 21, wherein the ceramic material comprises alumina, silicon nitride, aluminum nitride, silicon carbide, or silica.

27. The assembly of claim 21, wherein the ceramic material has a coefficient of thermal expansion in a range from about 5 parts per million per degree Centigrade to about 15 parts per million per degree Centigrade.

28. The assembly of claim 19, wherein the detector comprises a semiconductor material selected from the group consisting of silicon (Si), silicon germanium (SiGe), germanium (Ge), gallium arsenide (GaAs), indium phosphide (InP), gallium indium phosphide (GaInP), indium gallium arsenide (InGaAs), indium nitride (InN), selenium (Se), cadmium telluride (CdTe), cadmium zinc telluride (CdZnTe), cadmium oxygen telluride (Cd—O—Te), cadmium manganese oxygen telluride (Cd—Mn—O—Te), zinc telluride (ZnTe), zinc oxygen telluride (Zn—O—Te), zinc manganese oxygen telluride (Zn—Mn—O—Te), manganese telluride (MnTe), manganese oxygen telluride (Mn—O—Te), oxides of copper, carbon, mercuric iodide (HgI₂), lead iodide (PbI₂), lead oxide (PbO), thallium bromide (TlBr), thallium iodide (TlI), copper indium gallium seleninde (Cu—In—Ga—Se), and copper indium selenide (Cu—In—Se).

29. The assembly of claim 19, further comprising an under-fill.

30. An electronic assembly comprising:
a substrate having a plurality of conductive contacts disposed on a surface of the substrate, wherein the substrate comprises a dielectric material;
a detector having a plurality of conductive contacts disposed on a surface of the detector which is adjacent to the surface of the substrate;
a compliant interconnect disposed between the substrate and the detector, wherein the conductive contacts of the substrate and the conductive contacts of the detector are in electrical communication with the interconnect via a conductive epoxy, and wherein the compliant interconnect comprises a polymer core having an electrically conductive outer surface; and
an under-fill disposed between the surface of the substrate and the surface of the detector.

31. The assembly of claim 30, wherein the under-fill is an epoxy resin system.

32. The assembly of claim 31, wherein the epoxy resin system is a thermally, ultraviolet, or microwave curable epoxy resin.

33. An electronic assembly comprising:
a substrate comprising a dielectric material;
an interposer comprising a ceramic material;
at least one first interconnect disposed to establish an electrical communication between the interposer and the substrate via a solder joint;
a detector disposed over the ceramic interposer; and
at least one second interconnect disposed to establish an electrical communication between the detector and the interposer via a conductive epoxy joint, wherein the second interconnect comprises a polymer core having an electrically conductive outer surface; wherein the electrically conductive outer surface comprises gold.
